(19) United States
(12) Patent Application Publication
(10) Pub. No.: US 2004/0175123 A1
(43) Pub. Date: Sep. 9, 2004

(54) Network camera with embedded hub and network digital video recorder system including the same

(76) Inventors: Byeong-Jin Lim, Seoul (KR); In-Keon Lim, Seoul (KR); Seong-geon Bae, Seoul (KR)

Correspondence Address: VOLENTINE FRANCOS, P.L.L.C., Suite 150, 12200 Sunrise Valley Drive, Reston, VA, 20191, US

(21) Appl. No.: 10/792,764

(22) Filed: Mar. 5, 2004

(30) Foreign Application Priority Data
Mar. 8, 2003 (KR) 2003-0014554

(51) Int. Cl. H04N 5/781

(52) U.S. Cl. 386/95; 386/125

(57) ABSTRACT

A network digital video recorder system includes a plurality of network cameras, each of which is embedded with a switching hub that transmits a compressed video data packet from the network camera to the Ethernet. The switching hub embedded in the network camera multiplexes a compressed video data packet produced by the network camera, and a compressed data packet output by another (e.g., adjacent or neighboring) network camera, to up-link the multiplexed data packets to yet another neighboring network camera. Accordingly, video and audio data can be transmitted to a network digital video recorder through an Ethernet without cascading multiple dedicated hubs.

### CROSS REFERENCES TO RELATED APPLICATIONS

This application claims priority under 35 U.S.C. §119 from Korean Patent Application No. 2003-0014554, filed on Mar. 8, 2003, the contents of which are hereby incorporated by reference in their entirety for all purposes as if fully set forth herein.

### BACKGROUND AND SUMMARY

1. Technical Field

The present invention relates to a network digital video recorder system. More specifically, the invention relates to a network camera with an embedded hub or a switching hub, and a network digital video recorder system including a network camera with an embedded hub or a switching hub.

2. Description

A digital video recorder compresses video signals captured by a plurality of video cameras (for example, four or sixteen channels) connected by wires, and stores or displays the video signals. The digital video recorder is frequently used for the purpose of security of buildings, offices, ATMs and so on.

A video signal captured by a video camera is converted to an analog signal through a video encoder and transmitted to the digital video recorder. Then, the digital video recorder converts the analog signal to digital data through a video decoder, and compresses and stores the digital data or reproduces it.

The digital video recorder is one-to-one connected to a video camera through a cable. Accordingly, when 1600 video cameras are installed in one building, for instance, 1600 connection cables are required. When 16 channels are used, 100 digital video recorders are needed.

In a case where a specific building or area is monitored using thousands of video cameras, video signals should be transmitted to a control center from the video cameras using thousands cables. However, it is not easy to install thousands cables in the building or area.

To solve this problem, a network camera and network digital video recorder (DVR) were introduced. Techniques with respect to the network DVR are disclosed in WO02080033 and Korea Patent No. 2002-0018988.

FIG. 1 shows the construction of a conventional network digital video recorder system. The system includes a plurality of network cameras 55 connected through a plurality of hubs 90 to a network digital video recorder 60.

Each network camera 55 includes a camera module (not shown), a video encoder (not shown) and a data compressor (not shown). A compressed data packet output by the data compressor is delivered to the digital video recorder 60 through the Ethernet 70. Here, the camera module, video encoder and data compressor can be integrated or individually configured.

Furthermore, one can construct a simple Ethernet parallel wiring structure within a range that does not exceed the bandwidth of the Ethernet 70 using parallelism, which is a characteristic of an Ethernet.

In the meantime, the data packets that are encoded and compressed by each network camera 55 are sent through the Ethernet 70 to the network digital video recorder 60. The network digital video recorder 60 reproduces the data packets or stores them.

To connect the network camera 55 to the network digital video recorder 60 through the Ethernet network 70, a plurality of switching hubs 90 that perform a multiplexing function are required. For example, when 1600 network cameras 55 are cascade-connected, if a hub 90 that accommodates four ports is employed, 400+100+25+7+2=534 switching hubs are 90 needed.

Accordingly, a large number of hubs are required in the case where network cameras are installed in a large facility for security purposes. This is expensive, and it makes it difficult to install the network cameras and hubs.

Accordingly, it would be desirable to provide a network digital video recorder system having a plurality of network cameras and a network digital video recorder that receives data packets transmitted from the network cameras through an Ethernet, in which the network cameras are serially connected to the Ethernet without using hubs, to easily transmit compressed video data to the network digital video recorder.

It would also be desirable to provide a network digital video recorder system in which a plurality of network cameras are not cascade-connected to an Ethernet using hubs, but serially connected to the Ethernet and they transmit compressed video data packets to a network digital video recorder within a data transmission bandwidth of the Ethernet.

According to one aspect of the present invention, a network digital video recorder system, comprises: a plurality of network cameras, wherein each of the network cameras comprises: a video encoder adapted to convert an image captured by the network camera to a digital video signal; a data compressor adapted to compress the digital video signal output by the video encoder to produce first data packets; and an embedded hub adapted to receive data packets output by a second one of the network cameras to multiplex the first data packets produced by the data compressor and the second data packets received from the second network camera, and to output the multiplexed data packets; and a network digital video recorder adapted to receive the multiplexed data packets.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings:

FIG. 1 shows the construction of a conventional network digital video recorder system.

FIG. 2 shows the construction of a network camera embedded with a hub according to one or more aspects of the present invention.

FIG. 3 shows the construction of a network digital video recorder system using a network camera embedded with a hub according to one or more aspects of the present invention.

### DETAILED DESCRIPTION

Reference will now be made in detail to the preferred embodiments of the present invention, examples of which are illustrated in the accompanying drawings.

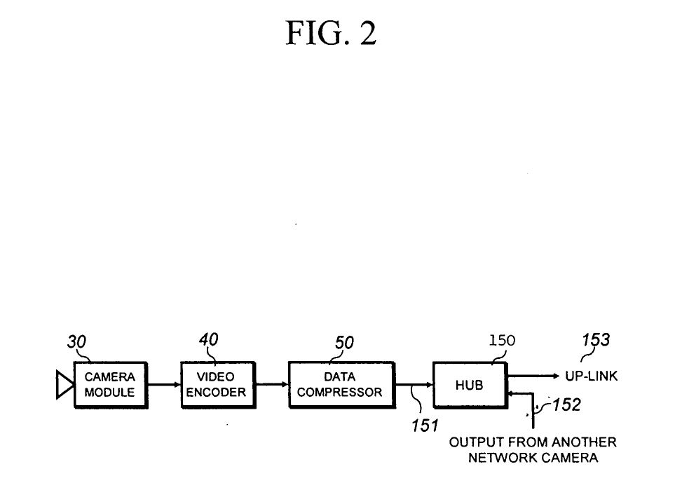

FIG. 2 shows the configuration of a network camera, including a camera module 30, a video encoder 40, a data compressor 50 and an embedded hub 150. The embedded hub 150 is understood to mean that the hub 150 is physically integrated with the network camera. The network camera shown in FIG. 2 can additionally include an audio (e.g., voice) encoder (not shown) that converts an audio (e.g., voice) input signal to a digital voice signal, and an audio (e.g., voice) signal compressor (not shown) to produce a compressed an audio (e.g., voice) signal for output by the network camera as data packets. Furthermore, the network camera can additionally have a central processing unit (not shown) for processing the compressed video signal and compressed voice signal. The network camera can include a signal input unit, an encoding unit, and a data compression unit of a conventional network camera, so detailed explanations for these components are omitted.

Significantly, the network camera of FIG. 2 includes a switching hub 150 embedded therein. The hub 150 multiplexes a compressed first data packet 151 output by the data compressor 50 of the same network camera in which the hub 150 is embedded, and a compressed second data packet 152 transmitted from another (e.g., a neighboring or adjacent) network camera, to transmit the multiplexed data packets to yet another neighboring network camera. That is, if one considers the network camera of FIG. 2 to be the n^{th} network camera in a network digital video recorder system having N cameras, then the hub 150 multiplexes compressed first data packets 151 output by the data compressor 50, and compressed second data packets 152 received from the (n−1)^{th} network camera, to transmit the multiplexed data packets to the (n+1)^{th} network camera.

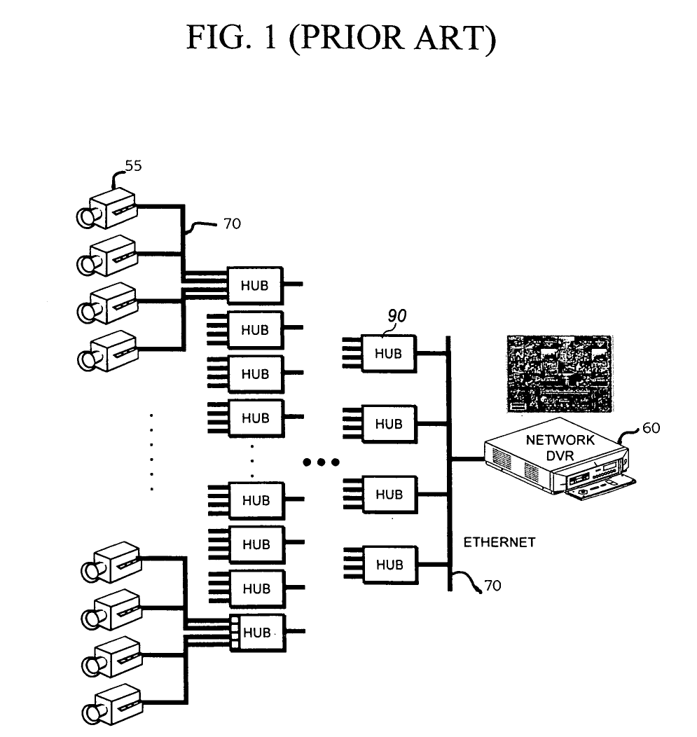

Accordingly, all of the network cameras can be serially connected using their embedded hubs 150. Furthermore, all of the network cameras can be connected to an Ethernet network 70 without using additional external hubs, as is required in the system of FIG. 1, which uses cameras without embedded hubs 150.

That is, with the network camera of FIG. 2, one can connect all of network cameras to one line in a ring fashion. While FIG. 2 shows that the hub 150 has only two input ports 151 and 152, the hub 150 can have more than two input ports. One input port 151 receives the data packet outputted from the n^{th} network camera in which the hub 150 is embedded, and the other input port 152 accepts the data packet from another network camera (the (n−1)^{th} network camera).

As described above, a hub is embedded in the network camera so that a large number of separate, dedicated hubs for cascade connection are not needed when a plurality of video cameras are connected to an Ethernet. Network cameras such as that shown in FIG. 2 can be simply serially connected together and up-linked to the Ethernet.

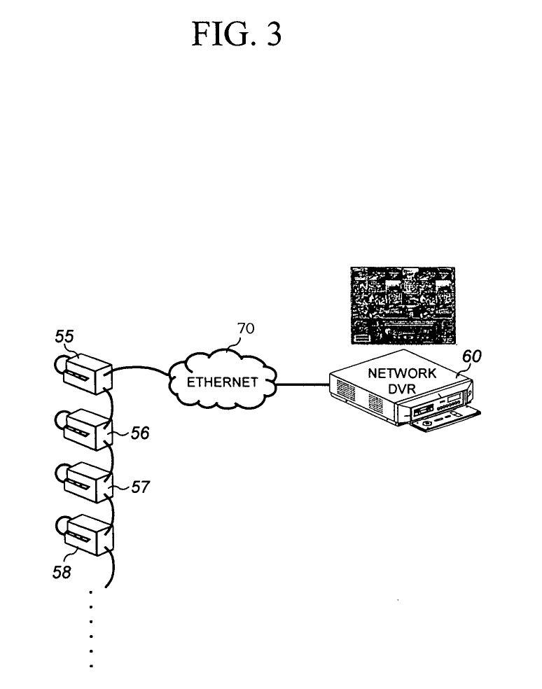

FIG. 3 shows a method of connecting a plurality of network cameras to the Ethernet. Referring to FIG. 3, each network camera is embedded with a hub including at least two input ports and one output up-link port. The output up-link port of a network camera 58 is connected to one input port of a network camera 57 such that the data packets output from the network camera 58, and the data packets output from the data compressor of the network camera 57, are multiplexed and up-linked to another network camera 56. Similarly, the output up-link port of the network camera 57 is connected to one input port of a network camera 56 such that the data packets output from the network camera 57 (which includes the data packets produced by both of the cameras 57 and 58), and the data packets output from the data compressor of the network camera 56, are multiplexed and up-linked to another network camera 55. The chain is continued until a last camera on the chain has its output up-link port connected to an Ethernet 70, which in turn is connected to the network digital video recorder 60. This last network camera thereby outputs a multiplexed data stream containing data packets from each of the network cameras.

In this manner, a plurality of network cameras can be connected to the Ethernet without using additional hubs. As described above, the network camera embeds a switching hub, which multiplexes a video data packet compressed by the camera's data compressor to be transmitted to an Ethernet, and a data packet outputted from another (e.g., neighboring or adjacent) network camera.

Accordingly, a plurality of network cameras can be serially connected, in contrast to the system of FIG. 1 in which the network cameras are connected in parallel using hubs. Therefore, when a network digital video recorder system is installed in a large building, the installation cost can be reduced and the system can be more easily installed.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments which can be embodies within a scope encompassed and equivalents thereof with respect to the feature set forth in the appended claims.

What is claimed is:

1. A network digital video recorder system, comprising:
a plurality of network cameras, wherein each of the network cameras comprises:
a video encoder adapted to convert an image captured by the network camera to a digital video signal;
a data compressor adapted to compress the digital video signal to produce first data packets; and
an embedded hub adapted to receive second data packets output by a second one of the network cameras, to multiplex the first data packets produced by the data compressor and the second data packets received from the second network camera, and to output the multiplexed data packets; and
a network digital video recorder adapted to receive the multiplexed data packets.

2. The network digital video recorder system of claim 1, wherein the network camera further comprises:
a voice encoder adapted to convert an audio signal to a digital audio signal; and
a data compressor adapted to compress the digital audio signal.

3. The network digital video recorder system of claim 2, wherein the network camera further comprises a central processing unit adapted to process the compressed video signal and the compressed audio signal.

4. The network digital video recorder system of claim 1, wherein the network camera further comprises a central processing unit adapted to process the compressed video signal prior to the first data packets being produced therefrom.

5. A network camera, comprising:
a video encoder adapted to convert an image captured by the network camera to a digital video signal;
a data compressor adapted to compress the digital video signal to produce first data packets; and
an embedded hub having two input ports and an output port,
wherein the first input port is adapted to receive the first data packets, the second input port is adapted to receive second data packets externally supplied, and the hub is adapted to multiplex the first and second data packets, and to output the multiplexed data packets via the output port.

6. The network camera of claim 5, further comprising
a voice encoder adapted to convert an audio signal to a digital audio signal; and
a data compressor adapted to compress the digital audio signal.
